(19) United States
(12) Patent Application Publication
(10) Pub. No.: US 2014/0311921 A1
(43) Pub. Date: Oct. 23, 2014

(54) PURIFICATION METHOD

(71) Applicants: Christopher Howard, London (GB); Neal Skipper, London (GB); Milo Shaffer, London (GB); Sian Fogden, London (GB)

(72) Inventors: Christopher Howard, London (GB); Neal Skipper, London (GB); Milo Shaffer, London (GB); Sian Fogden, London (GB)

(73) Assignee: UCL Business PLC, London (GB)

(21) Appl. No.: 14/008,657

(22) PCT Filed: Mar. 26, 2012
(86) PCT No.: PCT/GB12/00277

§ 371 Date: Jun. 12, 2014

(30) Foreign Application Priority Data
Mar. 30, 2011 (GB) 1105407.9

(51) Int. Cl. C01B 31/02

(52) U.S. Cl. CPC C01B 31/026
USPC 205/768

(57) ABSTRACT

A method for removing impurities from a sample of carbon nanotubes wherein the sample is contacted with an electronic liquid comprising a metal and an amine solvent is described.

The present invention relates to methods for removing impurities from carbon nanotubes. The methods may include further steps wherein the carbon nanotubes from which impurities have been removed are dispersed and then optionally separated by diameter, structure and/or electronic character, to produce sorted or fractionated material and solutions.

Nanoscaled carbon materials are of great technical and scientific interest. Carbon blacks have been known for a long time but have poorly defined structures. Recently, new classes of more perfect carbon nanostructures have been developed, including fullerenes and nanotubes. The most famous example of a fullerene is C₆₀, a pure carbon molecule with a specific symmetric and approximately spherical structure. The structure consists of edge-sharing hexagons and pentagons; exactly 12 pentagons are required to close the cage. Both larger and smaller fullerenes are known, by adding/removing (usually pairs of) carbon atoms. These larger fullerenes are usually also approximately spherical, due to a uniform distribution of the closure pentagons, but become increasingly polyhedral as they become larger due to localised strain at the pentagons.

Carbon nanotubes are related to fullerenes, but are structurally highly anisotropic. The closure pentagons are collected (6 at each end) to form ‘caps’ whilst the body of the tube is formed from a seamless cylinder of graphitic hexagons. There are no fundamental limits on aspect ratio, but around 1000 is typical, and 5,000,000 is known. The interesting properties of nanotubes are largely attributed to the hexagonal body, and indeed the end caps can be removed to form open tubes. Carbon nanotubes can be subdivided into two groups: single walled carbon nanotubes (SWNTs) and multiwalled carbon nanotubes (MWNTs).

SWNTs are pure carbon tubular molecules that can be thought of as a single ‘rolled up’ graphene sheet. SWNTs are typically about 1-1.5 nm in diameter, and their properties depend on their diameter and the angle at which they are rolled up from the graphene sheet (the chiral angle). Multiwalled carbon nanotubes consist of several concentric layers of SWNTS. There are several techniques for the production of carbon nanotubes. However, all result in a mixture of different diameters and chiralities.

The definitions of nanotubes can be extended to include a number of variants or derivatives familiar to those skilled in the art including, for example, the presence of defects (vacancies, other rings such as heptagons, and altered via hybridisation), endohedral material (filling of the hollow core with other substances), chemical functionalisation, di(or poly)merisation, and more complex topologies.

In general, synthesis techniques for nanotubes, and their derivatives, have poor selectivity, yielding a range of products with different specific characteristics. Furthermore, carbon nanotubes often contain undesirable impurities, such as carbonaceous impurities including micron-scale graphite, carbonaceous nanoparticles, metal-filled carbonaceous nanoparticles, fullerenes, so-called “schmutz” (imperfect fullerene cages and other sooty debris), amorphous carbon and polyaromatic hydrocarbons; and catalyst-derived impurities including catalyst metal particles, such as Fe, Ni, Co and Pd and catalyst support materials such as oxides including silica, alumina, zeolites and mesoporous silica. The presence of such impurities can cause problems in subsequent processing of the material and hence it is desirable to carry out a step in which impurities are removed from a sample of carbon nanotubes prior to further processing, such as dispersion and separation.

To date, the methods used for removing metallic and carbonaceous impurities have involved the use of heat, centrifugation and/or chemicals. Examples of techniques which have been used include competitive oxidations using gas and/or liquid phase reagents, including air, oxygen, water vapour, hydrogen peroxide, acidified permanganate, nitric acid, sulphuric/nitric acid mixtures; sonication; extraction of metals with hydrochloric acid; separation of nanotube-surfactant dispersions by centrifugation or dielectrophoresis; intercalation with a metal which may be oxidised. None of these methods provide an entirely satisfactory result; hence, combinations, repetitions, or sequences of multiple treatments are common. In addition to removing unwanted particulate impurities, the conditions used in these techniques cause damage to the carbon nanotubes, degrading desirable characteristics such as aspect ratio, electrical conductivity, mechanical strength, or spectroscopic/optoelectronic features. On the other hand, the impurities themselves degrade performance in many applications, for example by acting as initiation sites for mechanical failure of nanocomposites, by parasitically absorbing light in high transparency films, by quenching/absorbing fluorescence signals, etc.

Hence, there is a need for a simple yet effective method for removing unwanted impurities from carbon nanotubes which avoids damage to the carbon nanotubes.

In this regard, the present invention provides a method for removing impurities from a sample of carbon nanotubes comprising contacting the sample with an electronic liquid comprising a metal and an amine solvent.

Advantageously, the present inventors have found that an electronic liquid can be used to remove impurities from a sample of carbon nanotubes. This method is particularly advantageous because it avoids the use of agents which damage the nanotubes such that the nanotubes which remain after removal of the impurities are non-damaged and non-functionalised. Hence, the method of the present invention provides an ideal starting material for further manipulation, such as dispersion, separation and functionalisation.

A further advantage of the method of the present invention is the cleanliness of the process. More specifically, only metal and amine solvent are added, and the solvents are highly volatile and easily removed, leaving the pure metal nanotubide salts. Many of the metals themselves are volatile and can be removed by sublimation. This means that the metal can thus be recovered for reuse, leaving clean nanotubes from which the impurities have been removed.

A further advantage of the present invention is that it is possible to perform the method of the present invention on a sample of pure, as-synthesised carbon nanotubes without the need to carry out any pre-conditioning steps.

In the method of the present invention, the sample of nanotubes is contacted with an electronic liquid. This step has the effect of charging the impurities to generate anions which are then preferentially dissolved in the amine solvent.

The term “impurities” is used herein to refer to non-nanotube materials and includes both carbonaceous impurities and catalyst-derived impurities. Carbonaceous impurities include micron-scale graphite, carbonaceous nanoparticles, metal-filled carbonaceous nanoparticles, fullerenes, so-called “schmutz” (imperfect fullerene cages and other sooty debris), amorphous carbon and polyaromatic hydrocarbons. Catalyst-derived impurities include catalyst metal particles, such as Fe, Ni, Co and Pd and catalyst support materials such as oxides including silica, alumina, zeolites and mesoporous silica.

In general, the impurities present in a sample of carbon nanotubes fall into two categories, specifically those which are dissolvable such as most carbonaceous impurities and metals; and those which are not dissolvable such as catalysts support derived materials such as oxides and carbides as well as larger micron-scale graphite. Where the impurities are dissolvable, the method of the present invention works by preferentially dissolving such impurities in the amine solvent of the electronic liquid or in a further solvent to which the sample of carbon nanotubes is transferred after contact with the electronic liquid. The impurities may dissolve/disperse as discrete bonded species (e.g. fullerenes, carbon nanoparticles, polyaromatic hydrocarbons) or into atomic solution (e.g. some metals). Where the impurities do not dissolve in the electronic liquid or further solvent, the method of the present invention still allows for removal of impurities by controlling the metal content of the electronic liquid such that it is the material of interest which is dissolved and the impurities which remain undissolved.

In one embodiment, the present invention is primarily concerned with the removal of dissolvable impurities, in particular carbonaceous impurities which are notoriously difficult to remove. In this regard, in one embodiment, the present invention provides a method for removing carbonaceous impurities from a sample of carbon nanotubes comprising contacting the sample with an electronic liquid comprising a metal and an amine solvent.

The term “electronic liquid” is used herein to describe the liquids which are formed when a metal, such as an alkaline earth metal or an alkali metal, for example, sodium, dissolves without chemical reaction into a polar aprotic solvent—the prototypical example being ammonia. This process releases electrons into the solvent forming a highly reducing solution. Without wishing to be bound by theory, these solutions dissolve nanotubes, based on two factors. Firstly, the electrons can be directly solvated in the solvent allowing rapid charge transport and redistribution. The negative charge that builds up on the carbon species leads to electrostatic repulsion. In the polar aprotic solvent, these negatively charged species can be solvated and hence stably dispersed.

The nanotubes used in the present invention may be SWNTs or MWNTs. Preferably, the nanotubes are carbon nanotubes. The term “nanotube” is intended to cover a number of variants or derivatives familiar to those skilled in the art including, for example, the presence of defects (vacancies, other rings such as heptagons, and altered via hybridisation), endohedral material (filling of the hollow core with other substances), chemical functionalisation, di(or poly)merisation, and more complex topologies. The nanotubes may have a range of diameters. Typically, for SWNTs, the nanotubes will have diameters in the range from about 0.4 to about 3 nm. Where the nanotubes are MWNTs, the diameters will preferably be in the range from about 1.4 to about 100 nm. Preferably, the carbon nanotubes are SWNTs. Suitable nanotubes can be obtained commercially from many suppliers including SWeNT, Carbon Nanotechnologies Inc., Carbolex Inc. and Thomas Swan Ltd.

The metal used in the method of the present invention is a metal which dissolves in an amine to form an electronic liquid. The person skilled in the art will be familiar with appropriate metals. Preferably, the metal is selected from the group consisting of alkali metals and alkaline earth metals. Preferably, the metal is an alkali metal, in particular, lithium, sodium or potassium. Preferably, the metal is sodium. In one embodiment, a mixture of metals may be used.

It is advantageous to control carefully the amount of metal included in the solution. In particular, the present inventors have found that where the ratio of metal in the electronic liquid to carbon in the sample of nanotubes with which it is contacted is low, impurities are preferentially dissolved, hence the ability to remove impurities from a sample of carbon nanotubes. Therefore, preferably the metal is present in an amount such that the ratio of metal atoms in the electronic liquid to carbon atoms in the sample of carbon nanotubes with which the electronic liquid is contacted is less than about 1:20, about 1:30 or less, preferably about 1:40 or less, preferably about 1:50 or less, preferably about 1:60 or less, preferably about 1:70 or less, preferably about 1:80 or less, preferably about 1:90 or less, preferably about 1:100 or less, preferably about 1:150 or less, preferably about 1:200 or less, preferably about 1:250 or less. In some embodiments, the metal is present in an amount such that the ratio of metal atoms in the electronic liquid to carbon atoms in the sample of carbon nanotubes with which the electronic liquid is contacted is in the range from about 1:250 to about 1:30, about 1:200 to about 1:40, about 1:150 to about 1:50, about 1:120 to about 1:70, about 1:110 to about 1:90, in one embodiment, about 1:100. The molar ratio of metal to carbon atoms can be determined from their relative masses by simple calculations with which the person skilled in the art will be familiar.

In one embodiment, alternatively or in addition, it is advantageous to control carefully the ratio of metal in the electronic liquid to non-nanotube carbon atoms in the sample of carbon nanotubes with which it is contacted. Therefore, in one embodiment, the metal is present in an amount such that the ratio of metal atoms in the electronic liquid to non-nanotube carbon atoms in the sample of carbon nanotubes with which the electronic liquid is contacted is less than about 1:20, about 1:30 or less, preferably about 1:40 or less, preferably about 1:50 or less, preferably about 1:60 or less, preferably about 1:70 or less, preferably about 1:80 or less, preferably about 1:90 or less, preferably about 1:100 or less, preferably about 1:150 or less, preferably about 1:200 or less, preferably about 1:250 or less. In some embodiments, the metal is present in an amount such that the ratio of metal atoms in the electronic liquid to non-nanotube carbon atoms in the sample of carbon nanotubes with which the electronic liquid is contacted is in the range from about 1:250 to about 1:30, about 1:200 to about 1:40, about 1:150 to about 1:50, about 1:120 to about 1:70, about 1:110 to about 1:90, in one embodiment, about 1:100. The molar ratio of metal to non-nanotube carbon atoms can be determined using techniques such as thermogravimetric analysis (TGA) and UV-vis spectroscopy with which the skilled person will be familiar.

In the method of the present invention, an electronic liquid is formed by dissolving the metal in an amine solvent. In some embodiments, the amine solvent may be a C₁ to C₁₂ amine, a C₁ to C₁₀ amine, a C₁ to C₈ amine, a C₁ to C₆ amine, a C₁ to C₄ amine. The amine solvent is preferably selected from ammonia, methylamine or ethylamine. Preferably the amine solvent is ammonia.

In one embodiment, the metal is sodium and the amine solvent is ammonia.

It is preferred to exclude air and moisture from the system by ensuring that all materials are dry and oxygen-free. The skilled person will appreciate that it is not possible to establish a completely oxygen-free environment. Thus, as used herein, the term “oxygen-free” refers to an environment in which the content of oxygen is about 5 ppm or less.

The product of the method of the present invention is a sample of carbon nanotubes from which the impurities have been removed. In one embodiment of the method of the present invention, the content of impurities in the sample of carbon nanotubes after contacting with the electronic liquid is less than about 50%, less than about 40%, less than about 30%, less than about 20%, less than about 10%, less than about 5%, less than about 2%, less than about 1% of the content of impurities in the sample of carbon nanotubes prior to contacting with the electronic liquid. Preferably, the method of the present invention provides a sample of carbon nanotubes which is free from impurities.

The person skilled in the art will be familiar with techniques which may be used to confirm and quantify the removal of impurities. For example, the presence of carbonaceous impurities can be determined using Raman scattering techniques (Dresselhaus et al Physics Reports (2005), 47, 409). Raman scattering is the process of inelastic light scattering via an intermediate electron with energy lost or gained from a vibronic mode (phonon) of the sample. As only a very few phonons are scattered in this way (1 in 10⁷), Raman spectroscopy therefore typically uses a laser for a high intensity beam of monochromatic light.

Raman spectroscopy provides a semi-quantitative indication of the degree of purity of carbon nanotubes by comparing the relative intensity of the defect band (D-band) at ≈1350 cm⁻¹ and the graphite band (G-band) at ≈1590 cm⁻¹. An increase in the intensity of the D-band is correlated with the presence of contaminating carbonaceous impurities or damage to the nanotube framework. Hence, a low G/D value is indicative of carbonaceous impurities. The specific values may be reported as intensity ratios, or the ratios of peak integrals obtained from Gaussian/Lorentzian fits. In some cases, it is preferable to use the ratio of the D-band to the second order feature (sometimes called G′) at around 2600 cm⁻¹. The frequency of the excitation laser will affect the magnitude and selectivity of the measurement; ideally a range of lasers are used, although red (628 nm) and green lasers (514 or 532 nm) are common. In any case, the G/D ratios obtained are always a relative indicator of merit rather than an absolute. Other techniques for measuring carbonaceous impurity concentrations with which the skilled person will be familiar, use differential combustion in a thermogravimetric analyser (TGA) or the measurement of detailed UV/vis absorptions. In both cases, it is necessary to develop and calibrate the system depending on the specific nanotube materials which are to be used. For catalyst-derived impurities such as metals and catalyst support materials, relatively straightforward residual ash content, following TGA, or elemental analysis (eg by atomic emission/absorption spectroscopy or X-ray fluorescence/photoelectron spectroscopies) can be used.

Following the method of the present invention, the dispersed/dissolved fraction may be separated from the undissolved fraction by removing the liquid phase using a standard technique such as decanting, filtration, vacuum transfer, pressure driven cannula etc. Advantageously, because the method of the present invention does not require stirring, the need for a lengthy settling or centrifugation process is avoided, although such techniques may still be used in some embodiments. In one embodiment, the solvated material i.e. the dissolved material, contains predominantly impurities while the remaining material is comprised of purified carbon nanotubes which may be recovered by further evaporation of any remaining electronic liquid.

In one embodiment, in particular where the impurities are not dissolvable in the amine solvent, the sample of carbon nanotubes which has been contacted with the electronic liquid in the method of the present invention may be transferred to a different solvent, in particular a polar aprotic solvent, preferably a dry, oxygen free polar aprotic solvent, in order to dissolve the impurities. The polar aprotic solvent may be selected from the group consisting of tetrahydrofuran (THF), dimethyl sulfoxide (DMSO), ethers such as dioxane, amides such as dimethylformamide (DMF), N-methylpyrolidone (NMP), dimethyl acetamide (DMA), and hexamethylphosphorotriamide, acetonitrile and CS₂. In one embodiment, the polar aprotic solvent is THF. In an alternative embodiment, the polar aprotic solvent is DMF. In this embodiment, the amine solvent which formed a part of the electronic liquid is first removed to provide a charged nanotubide salt. The skilled person will be familiar with the fact that the suffix “-ide” is used to identify anionic components of salts. Hence, the term “nanotubide salt” refers to the anionic component, which comprises nanotubes, of the salt which is formed upon contacting the electronic liquid with the sample of carbon nanotubes. The nanotubide salt is then transferred to the polar aprotic solvent. It is not necessary to remove all of the amine solvent prior to transfer to the polar aprotic solvent and hence it may be that residual amine solvent is present. As described above, standard techniques may be used to remove the amine solvent.

After removing the impurities, one or more further steps may be carried out.

In one embodiment, the carbon nanotubes in the sample of carbon nanotubes from which impurities have been removed may be dispersed.

The skilled person will be familiar with a number of ways in which nanotubes may be dispersed. Examples include sonication of the SWNTs in an organic solvent (Coleman et al., Ad. Mater 2008, 20, 1876-1881), surfactant wrapping the nanotubes (O'Connell et al, Science 297, 593 (2002) and using super acids. While, any of these techniques may be employed to disperse the carbon nanotubes from which impurities have been removed by the method of the present invention, it is preferred that a dispersion step which avoids damage to the carbon nanotubes is employed.

One such technique is described in WO-A-2010/001128. This describes that a solution comprising a metal and an amine solvent may be used to produce a solution which comprises a high concentration of individual dispersed nanotubes. The inclusion of such a dispersion step following the purification step of the present invention is particularly advantageous because it employs the use of the same materials, specifically an electronic liquid, and so, in addition to not damaging the nanotubes, it can be carried out in the same apparatus with a minimal number of steps. Thus, in one embodiment, the method of the present invention comprises a further step of contacting the sample of nanotubes from which the impurities have been removed with a second electronic liquid comprising a metal and an amine solvent to disperse the nanotubes.

The metal and the amine solvent which comprise the second electronic liquid are as described above in connection with the electronic liquid used in the step of removing the impurities. However, in the dispersion step, the ratio of metal atoms in the second electronic liquid to carbon atoms in the sample of nanotubes from which the impurities have been removed, is higher than the corresponding ratio in the step wherein the impurities are removed. More specifically, it is advantageous to control carefully the amount of metal included in the second electronic liquid. Too much metal present in the electronic liquid washes out (saturates) the possibility of selective charging and prevents dispersion of the nanotubes by screening the electrostatic repulsions between the carbon species. Therefore, preferably the metal is present in an amount such that the ratio of metal atoms in the second electronic liquid to carbon atoms in the sample of carbon nanotubes from which the impurities have been removed and with which the second electronic liquid is contacted is about 1:4 or less, preferably about 1:6 or less, preferably about 1:8 or less, preferably about 1:10 or less, preferably about 1:15 or less, preferably about 1:20 or less. In some embodiments, the metal is present in an amount such that the ratio of metal atoms in the second electronic liquid to carbon atoms in the sample of carbon nanotubes from which the impurities have been removed and with which the second electronic liquid is contacted is in the range from about 1:20 to about 1:5, about 1:15 to about 1:8, about 1:10 to about 1:12, preferably about 1:10. As described above, the molar ratio of metal to carbon atoms can be determined from their relative masses by simple calculations with which the person skilled in the art will be familiar.

In one embodiment, the ratio of metal atoms in the second electronic liquid to carbon atoms in the sample of carbon nanotubes from which impurities have been removed is gradually increased to selectively disperse the nanotubes from which the impurities have been removed. This process may be done by either sequentially increasing the content of metal in the second electronic liquid or by contacting the nanotubes with a series of further electronic liquids which contain sequentially increasing amounts of metal atoms. Carbon nanotubes have variable electron affinities depending on type, diameter and helicity. Hence, using electronic liquids having a different metal content results in selective dispersion of the nanotubes. The term “selective dispersion” is used to refer to the situation wherein the nanotubes are dissolved sequentially in fractions wherein the nanotubes in any given fraction have similar properties which are different from those of another fraction. In an embodiment where a series of different electronic liquids are used to selectively disperse the nanotubes, each electronic liquid is removed before contact with the next.

In an alternative and preferred embodiment, the second electronic liquid is formed by increasing the metal content of the electronic liquid which remains after the purification step. This provides a simplified method for obtaining purified and dispersed carbon nanotubes without the need to change solvents. In this embodiment, preferably the amine solvent is ammonia.

In one embodiment, the amine solvent of the second electronic liquid may be removed to form a nanotubide salt which is then transferred to another solvent, preferably a polar aprotic solvent, preferably a dry and oxygen-free polar aprotic solvent.

In an alternative embodiment of the present invention, the nanotubes in the sample of nanotubes from which impurities have been removed may be dispersed using a technique as described in WO-A-2010-001125. More specifically, in one embodiment, the nanotubes from which impurities have been removed may be dispersed by an electrochemical process.

The term “electrochemical process” as used herein refers to a process wherein a chemical reaction takes place at the interface of an electron conductor (an electrode) and an ionic conductor (an electrolyte) and is a process which involves the transfer of a charged species between the electrode and the electrolyte.

Thus, in one embodiment, the method of the present invention may comprise a further step of applying a potential between a working electrode and a counter electrode, wherein the working electrode comprises the nanotubes from which the impurities have been removed, and the working electrode and counter electrode form part of an electrochemical cell which further comprises an electrolyte.

The term “working electrode” as used herein refers to an electrode at the interface of which an electrochemical process of interest takes place.

The working electrode comprises the nanotubes from which the impurities have been removed by the method of the present invention. Advantageously, the high purity of these nanotubes allows for the dispersion of a large quantity of nanotubes through a single simple process which can be easily controlled. In addition, it is straightforward to monitor for the end point of the dispersion step because it will be marked by the required degree of dissolution of the working electrode. Finally, the system is maintained free of unwanted additional contaminants.

The underlying principle of the electrochemical technique for dispersing the nanotubes from which impurities have been removed is to apply a relatively large potential between a working electrode which comprises the nanotubes and a counter electrode until the nanotubes becomes sufficiently highly charged that they spontaneously dissolve. The process may either use a large positive voltage to remove electrons from (oxidise) the nanotubes, leading to a solution of positively charged nanotubes, or use a large negative voltage to add electrons to (reduce) the nanotubes, providing a solution of negatively charged nanotubes. Preferably a large negative potential is applied such that the nanotubes are reduced. The reduction is preferred, as the required potential is more easily accessed in standard solvent windows, and the resulting carbon nanotubide ions are more easily solvated. Where the nanotubes are reduced, the working electrode is a cathode and the counter electrode is an anode.

As indicated above, in this electrochemical dispersion step, a large potential is applied between the working electrode and the counter electrode. The potential applied between the working electrode and the counter electrode may be adjusted depending on the ionisation energy of the nanotubes. Where a negative potential is applied, preferably the potential applied is about −0.6 V or a more negative potential, about −0.8 V or a more negative potential, preferably about −1.0 V or a more negative potential, preferably about −1.5 V or a more negative potential, preferably about −2.0 V or a more negative potential, preferably about −2.5 V or a more negative potential as measured relative to a standard hydrogen electrode. Preferably the potential applied is in the range from about −1 to about −2 V as measured relative to a standard hydrogen electrode.

Where a positive potential is applied, preferably the potential applied is about 1.0 V or more, preferably about 1.1 V or more, preferably about 1.2 V or more, preferably about 1.3 V or more, preferably about 1.5 V or more as measured relative to a standard hydrogen electrode. Preferably the voltage applied is about 3 V or less, about 2.5 V or less, about 2.0 V or less as measured relative to a standard hydrogen electrode.

The steady state current correlates with the rate of dissolution of the nanotubes, and may be maximised by adjusting the composition of the electrolyte and the surface area of the working electrode, as well as the applied potential.

The time for which a potential is applied between the working electrode and the counter electrode is not particularly limited, other than by consumption of the working electrode, which may be replenished. In one embodiment, the potential may be applied for a time in the range from about 1 to about 16 hours.

The dimensions of the working electrode are not particularly limited. In some embodiments, the working electrode may have a surface area in the range from about 0.2 to about 1.0 cm². In other embodiments, the surface area may be significantly larger, particularly where the method is being operated on a commercial scale.

The electrolyte is one that stabilises charged nanotubes. The electrolyte may be formed in situ in the electrochemical cell by addition of a suitable salt to a solvent. Standard, wide stability salts used for dry organic electrolyte systems can be used, including sodium tetraphenyl borate, tetrabutylammonium hexafluorophosphate and lithium perchlorate.

The person skilled in the art will be familiar with suitable solvents. In particular, polar, aprotic dry solvents are preferred. Suitable solvents for charged nanomaterials include but are not limited to dimethyl formamide (DMF), dimethylacetamide (DMA) and N-methylpyrolidone (NMP). Preferably these solvents are dry (i.e. water-free) and oxygen-free.

Alternatively, a nanomaterial-based electrolyte, such as a nanotube-based electrolyte can be used, for example, an alkali metal nanotubide salt, either prepared ex situ by direct reaction or in situ by the addition of alkali metal. Alternatively, the nanotube-based electrolyte may be a solution of the nanotubes from which the impurities have been removed by the method of the present invention in an electronic liquid comprising a metal and an amine solvent. In this embodiment, the electronic liquid is as defined previously in connection with the alternative method for dispersing the nanotubes once the impurities have been removed from the sample of carbon nanotubes.

It is preferred to exclude air and moisture from the system by ensuring that all materials are dry and oxygen-free.

In this embodiment of the method of the present invention, nanotubes are dissolved from the working electrode by applying a potential between the working electrode and the counter electrode. The electrochemical cell may contain a plurality of counter electrodes. The counter electrode used is not particularly limited, but is preferably electrochemically inert under the conditions employed. In this regard, the person skilled in the art will be familiar with appropriate counter electrodes. Examples of suitable counter electrodes include glassy carbon, graphite, platinum and nanotube papers.

In one embodiment, the electrochemical cell may further comprise a reference electrode or pseudo reference electrode. This addition is advantageous because it allows for maximum control, particularly in small scale experiments. In the solvent/electrolyte systems used in the method of the present invention, standard reference electrodes, most usually designed for or containing aqueous systems, are not always readily available, so a pseudo-reference electrode, such as a platinum wire, can be used. Some reference electrode systems such Ag/AgNO₃ are also available.

In one embodiment of the present invention, the working and counter electrodes are arranged in separate compartments linked by a suitable electrochemical membrane or separator. Suitable electrochemical membranes and separators include porous, for example, fluorinated polymer films, and glass or other inert fibre mats. In such an arrangement, the electrolyte salt or counter electrode material is oxidised (or reduced) at the counter electrode to balance the reduction (or oxidation) of nanotubes at the working electrode. The solution of charged, dispersed nanotubes can be collected from the working electrode compartment. Where the process is to be run in a continuous fashion, it may be necessary to add further additions of electrolyte or counter electrode material.

In an alternative embodiment, the working and counter electrodes are contained in a single compartment. In this arrangement, the nanotubes are dissolved from the working electrode and subsequently deposited onto the counter electrode(s). The process can continue until the nanotubes provided in the working electrode are exhausted, or until a selected fraction of the nanotubes provided in the working electrode are exhausted. The proportion of nanotubes which have been dissolved from the working electrode can be determined by monitoring the weight of the working electrode as the electrochemical reaction progresses or by measuring the total charge which has passed through the electrochemical cell by integrating current over time. The deposited nanotubes can be collected from the counter electrode, for example, by mechanical means to produce a powder or by further electrochemical processing to produce a dispersion.

Preferably, the electrochemical cell used is arranged such that the working and counter electrode(s) are contained in the same compartment.

Nanotubes are heterogeneous, and the various components have different redox potentials as described in Okazaki, K. et al. Physical Review B, 2003, 68(3). Accordingly, by selecting the potential of the working electrode, different fractions of nanotube-containing material may be dissolved. Hence, the nanotubes from which the impurities have been removed may be selectively dispersed, depending on the properties of the nanotubes. This selectivity may be achieved in one of two ways. In one embodiment, separation may be achieved by controlling the dissolution of the nanotube-containing working electrode. This can be done by controlling the potential applied between the working electrode and the counter electrode. Metallic or diameter-dependent semiconducting nanotubes may be dissolved separately, optionally in a sequence of applied potential steps of gradually increasing magnitude. Where separation is achieved by controlling dissolution of the working electrode, preferably the potential applied between the working electrode and the counter electrode is sufficient to dissolve at least about 1%, at least about 5%, at least about 10%, at least about 15%, at least about 20%, at least about 25%, at least about 30%, at least about 35%, at least about 40%, at least about 45%, at least about 50%, at least about 60%, at least about 70%, at least about 80%, at least about 85%, at least about 90%, at least about 95%, at least about 98%, at least about 99% of the nanotubes of the working electrode.

In this embodiment where the method of the present invention includes an electrochemical dispersion step is included, the product obtained is a solution of dispersed, individual, charged nanotubes which have optionally been separated on the basis of size, helicity and/or electronic character by adjusting the potential applied between the working electrode and counter electrode so as to control dissolution of the nanotube-containing working electrode.

In an alternative embodiment, separation of the nanotubes may be achieved by controlling the deposition of the dissolved nanotubes onto the counter electrode. In this embodiment, preferably, a sufficiently large potential is applied between the working electrode and the counter electrode in order to dissolve at least about 50%, at least about 60%, at least about 70%, at least about 80%, at least about 85%, at least about 90%, at least about 95%, at least about 98%, about 100% of the nanotubes of the working electrode. The electrochemical cell may comprise a plurality of counter electrodes, such that the potential between the working electrode and each subsequent counter electrode is different. The differing redox potentials of the charged species will cause them to be selectively deposited at different counter electrodes, allowing for separation of the nanotubes from which the working electrode is comprised. Preferably, the counter electrodes are spatially arranged in sequence in terms of distance from the working electrode, such that the dissolved species move sequentially from smallest to greatest magnitude potential. This arrangement allows for the deposition of a pure species at each counter electrode as it reaches the potential required for deposition.

The nanotubes produced by the method of the present invention have immediate application in such fields as solar cells, transistors and sensing. In particular, dispersed nanotubes can be used for variety of purposes, including preparation of coatings, composites, and synthesis of functionalised nanotubes using reactions developed for nanotubes charged by chemical means.

The person skilled in the art will be familiar with techniques which may be used to confirm the presence of individualised dispersed nanotubes. An example of a suitable technique is small angle neutron scattering (SANS). Details of the SANS technique are described in Fagan et al., J Phys Chem B., (2006), 110, 23801.

SANS is a powerful technique for probing the structure of SWNTs in solution. More specifically, SANS can be used to determine whether the SWNTs are present as isolated species or in bundles or clusters. SANS provides information of the structure of large particles in solution (in the range from 1 to 1000 nm). The SANS intensity I(Q) is proportional to Q^{-D}, where D is the fractal dimension of the tube. Thus, the expected SANS pattern for fully dispersed rod-like objects (i.e. D≈1) is Q⁻¹ behaviour. Otherwise, non-mono-dispersions of SWNTs, i.e. those consisting of aggregates or networks of rods exhibit a larger fractal dimensions, typically from 2 to 4.

Where the method of the present invention includes a dispersion step as described above, it is possible to obtain solutions which contain high concentrations of nanotubes. More specifically, concentrations of greater than about 0.01 mgml⁻¹ may be achieved. In one embodiment, the concentration of individual nanotubes after the dispersion step is about 0.1 mgml⁻¹ or more, about 0.5 mgml⁻¹ or more, about 1 mgml⁻¹ or more, about 5 mgml⁻¹ or more, about 10 mgml⁻¹ or more, about 50 mgml⁻¹ or more, about 100 mgml⁻¹ or more.

A further advantage associated with the dispersion steps is that selectivity is achieved. More specifically, the nature of the separation methods are such that metallic carbon nanotubes are charged in preference to semi-conducting nanotubes. The effect is due to the variable electron affinity of SWNTs which depends on type, diameter, and helicity.

The types of nanotubes which are present in the solution can be determined by Raman scattering techniques. SWNTs are rolled up sheets of graphite and due to this tubular nature their electrons are confined in the radial direction of the tube. This quantisation leads to large spikes, called van Hove singularities, in their electronic Density of States (eDOS). If the incoming light matches the difference between these spikes, the Raman scattering is resonant. The Raman spectrum at any given wavelength is then dominated by the specific tubes which have transitions matching that wavelength in their eDOS. To predict which tubes will be in resonance with the light, a Kataura plot is often used. This graph is a plot of calculations of the transitions of different SWNTs as a function of their diameter.

Below 400 cm⁻¹, the Raman spectra of SWNTs are dominated by the Radial Breathing Modes (RBM). The energy of this phonon is inversely proportional to the diameter of the SWNT. The Raman spectra of a sample of a mixture of tubes will show a sum of the peaks from all the RBMs from the SWNTs that are resonant with the light. Therefore, knowing the laser wavelength, one can read off from the Kataura plot which tubes are present in a given sample. If one takes a sample of SWNTs and processes it chemically, then by comparing its Raman spectrum with that of the untreated tubes, the relative population increase or decrease in the RBMs provides strong evidence of the relative increase or decrease of the specific type of SWNT in the sample. Furthermore, as can be seen in the plot, transitions from metallic and semi-conducting tubes are typically well separated for given energies. Thus, typically a spectrum contains reasonably clear regions of peaks corresponding to metallic and semiconducting SWNTs. In this way Raman Spectroscopy is a powerful technique in determining the extent of separation of SWNTs based on electronic character. Jorio A., New J. Phys., (2003), 5, 139 describes the use of this technique for characterising carbon nanotubes.

After producing a solution of dispersed individual nanotubes, optionally one or more further steps may be carried out. In particular, the dispersion of individual nanotubes may be separated on the basis of diameter, structure, helicity and/or electronic character.

In one embodiment, dispersion and separation of the carbon nanotubes in the sample of carbon nanotubes from which impurities have been removed may occur simultaneously e.g. by control of the dispersion step, only one fraction of nanotubes is dispersed.

In one embodiment, the purified and dispersed nanotubes may be transferred to a different solvent, in particular a polar aprotic solvent. The polar aprotic solvent may be selected from the group consisting of tetrahydrofuran, dimethyl sulfoxide, ethers such as dioxane, amides such as dimethylformamide, N-methylpyrolidone, dimethyl acetamide and hexamethylphosphorotriamide, acetonitrile and CS₂. In one embodiment, the polar aprotic solvent is tetrahydrofuran. In an alternative embodiment, the polar aprotic solvent is dimethyl formamide (DMF). Preferably the polar aprotic solvent is dry and oxygen-free.

In one case, the dispersed nanotubes may be separated by gradual quenching of the charge using a suitable quenching agent, including but not limited to O₂, H₂O, I₂, and alcohols (or other protic species). As the quenching agent is added, the species with the highest energy electrons will be deposited first. By adding appropriate stoichiometric quantities, the desired fractions may be separated. For example, the fractions precipitated after neutralising predetermined amounts of the total charge may be collected.

Alternatively or in addition to chemical quenching, an electrochemical quenching method may be used. In this case the addition charge on the individual nanotube-based anions is removed by applying a voltage to an (otherwise inert) electrode placed in the dispersion of nanotubes.

By controlling the potential of the electrode, nanotubes of different electron affinities can be oxidised and precipitated onto the electrode. The electrode (or series) of working electrodes may be held at fixed potential(s), in potentiostatic mode. A counter electrode may also be provided, preferably in a remote, though ionically-linked compartment, at which the metal ion is reduced and recovered. A reference electrode may be used to control the potential at the working electrode accurately.

Alternately, or in an additional step, the solvent may gradually be removed, causing the heaviest/least charged species to deposit first. These two mechanisms allow separation by, for example, nanotube length on the one hand, and nanotube electronic character (semiconducting band gap) on the other.

Optionally, quenching agents, including but not limited to RI, wherein R is a hydrocarbon group can be used to chemically modify the carbon species. By carrying out the reaction on dispersions of individual nanotubes, an ideally uniform functionalisation is achieved over the nanotube surface as typical functionalisations occur only on the surface of nanotube bundles.

Optionally, a solution of (previously separated) carbon species can be destabilised slowly (by quenching or solvent removal) to crystallise the carbon species.

Alternatively or in addition, individualised, dispersed nanotubes, may be further separated according to size by chomatrography in a dry environment.

Optionally, the charged individual nanotubes can be transferred to other dry organic solvents, such as dimethyl formamide (DMF), dimethylacetamide (DMA) and N-methylpyrolidone (NMP), for further processing.

The primary products of the process of the present invention are carbon nanotubes which are not contaminated with impurities, in particular carbonaceous impurities which are notoriously difficult to remove. Furthermore, by including a dispersion step as described herein, monodispersed, undamaged, nanocarbons or nanocarbon salts, such as nanotubide salts, which are not contaminated with impurities may be provided.

The method of the present invention provides a product which is a very useful starting material for further manipulation of carbon nanotubes. In particular, the elimination of impurities is advantageous. Once separated, monodispered solutions of carbon species can be made that are particularly suitable for forming ordered complex fluids and films. For example a solution of dispersed individual carbon nanotubes can be produced at a concentration suitable for the formation of a nematic phase, which is desirable for alignment of nanotubes, or other further processing, including crystallisation.

The present invention will now be described further by reference to the following figure and example which are in no way intended to limit the scope of the invention.

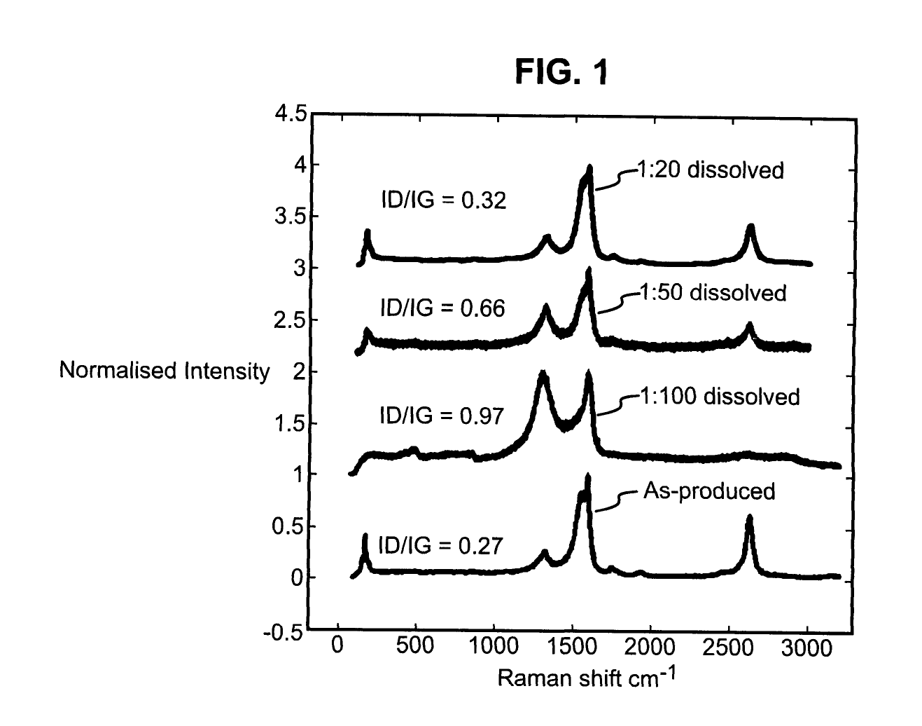

FIG. 1 shows Raman spectra taken at 632 nm laser for as-produced ARC single walled nanotubes (SWNTs) and spontaneously dissolved ARC SWNTs charged in electronic liquid wherein the metal content of the electronic liquid is controlled to provide metal:carbon ratios of 1:20, 1:50 and 1:100, respectively.

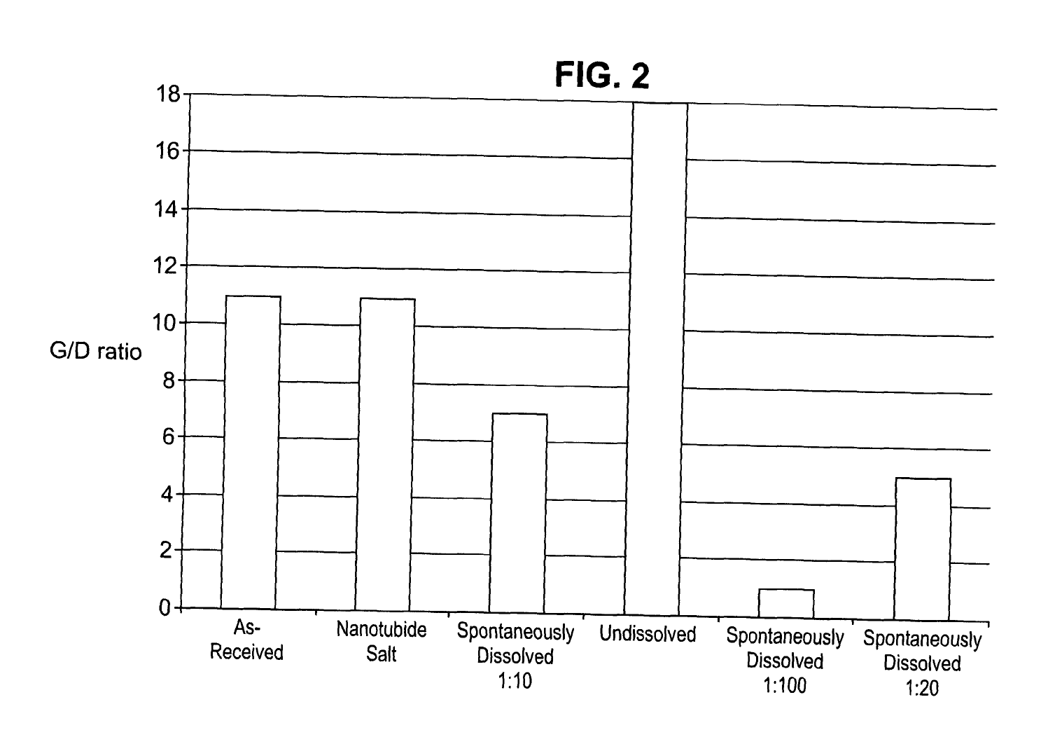

FIG. 2 shows I_{G}/I_{D} ratios of the Raman spectra taken at 632 nm laser for: as-produced CoMoCat SWNTs; spontaneously dissolved CoMoCat SWNTs charged in electronic liquid wherein the metal content of the electronic liquid is controlled to provide metal:carbon ratios of 1:10, 1:20 and 1:100; the fraction in the 1:10 sample which did not dissolve; and a SWNT salt formed in electronic liquids at 1:10 ratio.

### EXAMPLE 1

As-produced grade Single-Walled Carbon Nanotubes (SWNTs) were obtained from Carbolex, Inc., USA. This product consists of different types of SWNTs as well as catalyst residue impurities and carbonaceous impurities. The as-produced SWNTs were heated to a temperature in the range 180° C. to 220° C. and preferably around 200° C. under a dynamic vacuum for 24 hours to remove adsorbed species. The sample was then loaded in a specially designed clean glass cell, along with sodium metal in an argon glovebox (O₂ and H₂O<1 ppm). The stoichiometric ratio of carbon to metal was carefully controlled to give a ratio of one sodium atom to every 100 carbon atoms based on the total carbon in the sample of carbon nanotubes. The amount of carbon was typically 100 mg. The glass cell was connected to a stainless steel, leak tight gas rig and cooled to approximately −50° C.

Following this, high purity anhydrous ammonia was condensed onto the sample. This was done by transferring a known amount, typically 1.5 bar of ammonia gas, into a 300 cm⁻³ volume flask at room temperature and measuring the pressure before opening this flask to the sample container to allow the ammonia to condense onto the sample. This process was repeated so that a total of typically 30 bar (measured in 300 cm⁻³ at room temperature) was transferred onto the sample (about 8 cm⁻³ of liquid ammonia). Immediately, the solution formed a deep blue colour which can be attributed to solvated electrons present due to the dissolution of sodium metal in the ammonia. After a period of about an hour, the solution cleared (i.e. the blue colour of the solution disappeared) indicative of the transfer of the solvated electrons onto the more readily reduced components of the as-produced SWNTs. These charged species then dissolved and the solution became a brown/black colour. The solution was left to equilibrate for 2 hours. Following this the ammonia was slowly removed. The resulting salt was then transferred in rigorously dry conditions to another dry solvent, typically DMF. The tubes were left to dissolve over a period of several days until a homogenous brown/black solution was formed. The dissolved fraction was then carefully removed by cannula and precipitated out by quenching in air. This process was repeated for metal:carbon ratios of 1:50 and 1:20, respectively.

The process outlined above was repeated using as-produced CoMoCat tubes as a starting material; these were obtained from SouthWest NanoTechnologies Inc. In this case, metal:carbon ratios of 1:10, 1:20, 1:100 were used. In the case of the 1:10 sample the fraction of the sample that did not dissolve in the DMF was also isolated, as well as the salt (called ‘nanotubide salt’) that was produced after the ammonia was removed and before the DMF was added. In the case of all the CoMoCat samples, there is no dissolution in the liquid ammonia following charging in the electronic liquid, but spontaneous solvation does occur when subsequently added to the DMF.

For all samples, Raman spectra were recorded with a 632 nm laser.

FIG. 1 shows the Raman spectra for the as-produced, 1:20, 1:50 and 1:100 samples taken using a 632 nm laser. The relevant features are the radial breathing modes RBMs (Raman shift<300 cm-1), the D mode (˜1300 cm-1), the G⁻ mode (˜1500-1570 cm-1) and the G⁺ mode (˜1590 cm-1).

The presence of the RBMs confirms the existence of SWNTs in the sample (Dresselhaus et al, Phys. Rep., 409, 47, (2005)). The D peak is activated by disorder scattering and is therefore an indication of defects or amorphous carbonaceous impurities in SWNTs (Ferrari A. C and Robertson J. Phys. Rev. B (2000), Dresselhaus et al, Phys. Rep., 409, 47, (2005)). Although exact quantitative analysis is difficult due to the intricacies of the Raman scattering process, a strong indication of the amount of carbonaceous impurities/defects is given by the size of the D/G intensity ratio: the lower the ratio, the fewer carbonaceous impurities or defects are present in the sample (Ferrari A. C and Robertson J. Phys. Rev. B (2000), Dresselhaus et al, Phys. Rep., 409, 47, (2005)).

FIG. 1 shows that for a sample where the electronic liquid includes metal atoms in an amount to provide a 1:100 ratio of metal to carbon in the sample of carbon nanotubes, a) the RBMs not visible; and b) the D to G ratio (I_{D}/I_{G}) is vastly increased relative to the as-produced sample, indicating the carbon content of the dissolved fraction consists predominantly of amorphous carbonaceous impurities, hence removal of impurities has been achieved.

Where the content of metal atoms in the electronic liquid is controlled to provide a metal:carbon ratio of about 1:50, the I_{D}/I_{G} ratio has decreased and RBMs are visible in the spectrum confirming that despite the presence of carbonaceous impurities, a significant proportion of the dissolved fraction is SWNTs.

Finally, where the content of metal atoms in the electronic liquid is controlled to provide a metal:carbon ratio of about 1:20 metal to carbon ratio, an even greater proportion of the dissolved fractions are SWNTs.

FIG. 2 shows a summary of the I_{G}/I_{D} ratios for the CoMoCat samples. It can be seen that for the spontaneously dissolved fractions, the lower the ratio of metal in the electronic liquid to carbon in the sample of carbon nanotubes, the lower the I_{G}/I_{D} ratio. This indicates that at low metal:carbon ratios, carbonaceous impurities are preferentially dissolved. The I_{G}/I_{D} ratio of the undissolved fraction can be seen to have increased from the as-received sample confirming that the process has removed impurities from the sample. The I_{G}/I_{D} ratio of the nanotubide salt is very similar to that of the as-received material showing this ratio is not affected by simply charging the sample in electronic liquids.

1. A method for removing impurities from a sample of carbon nanotubes comprising contacting the sample with an electronic liquid comprising a metal and an amine solvent.

2. A method according to claim 1, wherein the ratio of metal atoms in the electronic liquid to carbon atoms in the carbon nanotubes with which the electronic liquid is contacted is about 1:50 or less.

3. A method according to claim 1, wherein the ratio of metal atoms in the electronic liquid to carbon atoms in the carbon nanotubes with which the electronic liquid is contacted is about 1:100 or less.

4. A method according to claim 1, wherein the metal is selected from the group consisting of alkali metals and alkaline earth metals.

5. A method according to claim 4, wherein the metal is an alkali metal.

6. A method according to claim 1, wherein the metal is a mixture of metals.

7. A method according to claim 1, wherein the amine is ammonia.

8. A method according to claim 1, comprising a further step of removing the amine solvent to form a nanotubide salt.

9. A method according to claim 1 comprising a further step of transferring the sample of carbon nanotubes with which the electronic liquid has been contacted to a solvent.

10. A method according to claim 9, wherein the solvent is a polar aprotic solvent.

11. A method according to claim 1 comprising a further step of contacting the sample of nanotubes from which the impurities have been removed with a second electronic liquid comprising a metal and an amine solvent to disperse the nanotubes.

12. A method according to claim 11, wherein a solution of individual nanotubes is produced which is free from impurities.

13. A method according to claim 11, wherein the ratio of metal atoms in the second electronic liquid to carbon atoms in the carbon nanotubes with which the second electronic liquid is contacted is greater than the ratio of metal atoms in the electronic liquid to carbon atoms in the carbon nanotubes with which the electronic liquid is contacted to remove impurities.

14. A method according to claim 13, wherein the metal is included in the second electronic liquid in an amount such that the ratio of metal atoms in the second electronic liquid to carbon atoms in the nanotubes with which the second electronic liquid is contacted is about 1:10 or less.

15. A method according to claim 13, wherein the metal is included in the second electronic liquid in an amount such that the ratio of metal atoms in the second electronic liquid to carbon atoms in the nanotubes with which the second electronic liquid is contacted is in the range from about 1:15 to about 1:10.

16. A method according to claim 1, wherein the nanotubes from which the impurities have been removed are contacted with a further electronic liquid and wherein the ratio of metal atoms in the further electronic liquid to carbon atoms in the nanotubes with which it is contacted is gradually increased to selectively disperse the nanotubes.

17. A method according to claim 1, comprising a further step of dispersing the nanotubes by applying a potential between a working electrode and a counter electrode, wherein the working electrode comprises the nanotubes from which the impurities have been removed and the working electrode and counter electrode form part of an electrochemical cell which further comprises an electrolyte.

18. A method according to claim 17, wherein a positive potential is applied between the working electrode and the counter electrode.

19. A method according to claim 17, wherein a negative potential is applied between the working electrode and the counter electrode.

20. A method according to claim 17, wherein the electrolyte is a dry polar, aprotic solvent.

21. A method according to claim 17, wherein the electrolyte is a nanotube-based electrolyte.

22. A method according to claim 21, wherein the electrolyte comprises the nanotubes from which the impurities have been removed.

23. A method according to claim 17, wherein the electrochemical cell further comprises a reference electrode.

24. A method according to claim 17, wherein the electrochemical cell comprises a plurality of counter electrodes and a different potential is applied between the working electrode and each counter electrode.

25. A method according to claim 17, wherein the working electrode and counter electrode are contained within a single compartment.

26. A method according to claim 17, wherein the working electrode is contained within a first compartment and the counter electrode is contained within a second compartment, wherein the first and second compartments are linked by an electrochemical membrane.

27. A method according to claim 17, wherein the nanomaterial from which the impurities have been removed is selectively dispersed by controlling the potential applied between the working electrode and the counter electrode.

28. A method according to claim 1, comprising a further step of separating the dispersed nanotubes.

29. A method according to claim 1, which comprises a further step of removing the electronic liquid to provide purified or fractionated nanotubes.

30. A method according to claim 1, which comprises a further step of transferring the nanotubes to a solvent.

31. A method according to claim 30, wherein the solvent is a polar aprotic solvent.

32. A method according claim 31, wherein the polar aprotic solvent is selected from the selected from the group consisting of tetrahydrofuran (THF), dimethyl sulfoxide (DMSO), ethers such as dioxane, amides such as dimethylformamide (DMF), N-methyl pyrolidone (NMP), dimethyl acetamide, and hexamethylphosphorotriamide, acetonitrile and CS2.

33. (canceled)
